(19) United States
(12) Patent Application Publication
(10) Pub. No.: US 2005/0207307 A1
(43) Pub. Date: Sep. 22, 2005

(54) Write pulse optimizing method

(75) Inventor: Takahiro Ohkubo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/042,153

(22) Filed: Jan. 26, 2005

(30) Foreign Application Priority Data
Jan. 28, 2004 (JP) 2004-019651

(51) Int. Cl. G11B 7/12

(52) U.S. Cl. 369/59.11

(57) ABSTRACT

According to the present invention, write pulses are optimized without being affected by the level of skill of an engineer. The present invention relates to the optimization of write pulses for an optical disk recording apparatus for recording an optical signal to, e.g., a DVD-R. A common write pulse which does not depend on various recording conditions is initially set. Pulse set positions affecting on recording quality are sequentially determined in accordance with an adjustment sequence, thus obtaining write pulses suitable for an actual operating environment. In each adjustment step, test recording is performed and a jitter value is measured. Based on a margin curve (quadratic approximation curve) of jitter values obtained by measurements, the optimum setting is obtained. This process is repeated every ordered pulse adjustment position. Finally, recording quality including margin is checked, thus optimizing the write pulses.

### BACKGROUND OF THE INVENTION

1. Field of the Invention

The present invention relates to a write pulse optimizing method for optimizing write pulses used in recording information to various recording media such as an optical disk and the like.

2. Description of the Related Art

Generally, it is important that each write pulse for an optical disk is optimized in consideration of the kind of recording medium, recording rate, the control characteristics of optical power (OP), and variations between circuit boards to obtain stable recording quality.

FIG. 9 is a diagram explaining write pulses used in a DVD recordable (DVD-R) as examples of conventional write pulses.

To improve the recording quality of a DVD-R, various manufacturers propose write strategies with various new ideas. As shown in FIG. 9, non-multi type high-speed (HS) write pulses shown in a dashed line A or a pulse-train type low-speed (LS) write pulses shown in a dashed line B are properly used depending on recording rate.

Edge timings (positions) of respective waveforms and the longitudinal levels shown by small arrows in FIG. 9 are adjustable parameters affecting the recording quality. A recording engineer determines those adjustable parameters while evaluating the length of each generation pulse for a pit or a land, a jitter measurement value, and write power, thus optimizing the write pulses.

Various control methods for optimizing write pulses have been proposed. For example, U.S. Patent Application Publication No. 2002/0009034 discloses a method for compensating set write pulses and pulses emitted by a semiconductor laser. Japanese Unexamined Patent Application Publication No. 2001-167436 discloses a method for properly setting recording density by a process of optimizing recording conditions before recording. U.S. Patent Application Publication No. 2002/0071366 and PCT Patent No. WO 02/101734 disclose methods for optimizing laser power depending on an operating condition such as high-rate recording or pulse train recording. However, these related arts do not sufficiently suggest an approach for optimizing write pulses in detail.

Regarding the above-mentioned method for optimizing write pulses based on the determination of adjustable parameters by the recording engineer, the effect of the optimization depends to a large degree on the recording engineer's experience. Since the number of adjustable parameters is large, a skilled engineer performs the pulse optimization at much expense in time. Disadvantageously, the procedure is complicated and the optimization has a large variation in effect.

In addition, it is difficult for engineers with little experience to achieve the optimization.

### SUMMARY OF THE INVENTION

Accordingly, it is an object of the present invention to provide a write pulse optimizing method capable of easily and stably optimizing write pulses without being affected by the level of skill of an engineer.

To accomplish the above object, the present invention provides a write pulse optimizing method for changing a set parameter of a write pulse depending on the length of a pit to be formed in recording write pulses serving as information signals to an optical recording medium to optimize the write pulses, the method including the steps of: a first step of setting a common write pulse which does not depend on individual recording conditions and affects the entire recording operation; and a second step including a plurality of adjustment blocks for optimizing the set parameter of a write pulse for each pit length depending on the individual recording conditions, wherein after the common write pulse is set in the first step, the adjustment blocks in the second step are executed in a predetermined order to perform an optimization sequence of step-by-step adjustments of the set parameters of the write pulses.

According to the write pulse optimizing method of the present invention, after the common write pulse is set, the optimization sequence of executing the adjustment blocks, corresponding to respective recording conditions for the respective lengths of pits to be formed, in a predetermined order to adjust the set parameters of the write pulses in a step-by-step manner is performed. Advantageously, write pulses can be easily and stably optimized without being affected by the level of skill of an engineer.

It is known that write pulse optimization is not effectively performed by changing only one pulse position. For example, referring to FIG. 9, in the HS (high-speed pulse) operation, the entire duration of each pulse is narrowed and the durations of column pulse segments (top and tail pulses) are increased. In the LS (low-speed pulse) operation, the duration of each top pulse is increased and the duration of each tail pulse is narrowed. However, since the influence on recording quality is characterized every pulse adjustment position, the adjustments can be ordered.

According to the present invention, a typical write pulse common to pits and lands is initially prepared. Then, recording is performed while a pulse set parameter is being changed. Based on a margin curve (quadratic approximation curve) of jitter values obtained by measurements, the optimum setting is obtained from this quadratic approximation curve. This process is repeated every ordered pulse adjustment position. In other words, pulse adjustment positions are sequentially adjusted in descending order of influence on recording quality. Finally, the recording quality including margin is checked, thus optimizing write pulses.

### BRIEF DESCRIPTION OF THE DRAWINGS

FIG. 1 is a flowchart of a process of a write pulse optimizing method according to an embodiment of the present invention;

FIG. 2 is a flowchart of the process of the write pulse optimizing method according to the embodiment of the present invention;

FIGS. 3A to 3D are diagrams explaining specific examples of optimizations in adjustment blocks of an optimization sequence according to the embodiment in FIG. 1 and FIG. 3E shows the principle of measuring 3T-pit/land jitters to select the optimum pulse position;

FIGS. 4A and 4B are diagrams explaining write pulse waveforms observed by a measuring device, the waveforms corresponding to steps S1 and S3 of the flowchart in FIG. 1;

FIGS. 5A and SB are diagrams explaining write pulse waveforms observed by the measuring device, the waveforms corresponding to steps S5 and S6 of the flowchart in FIG. 1;

FIGS. 6A and 6B are diagrams explaining write pulse waveforms observed by the measuring device, the waveforms corresponding to steps S7 and S8 of the flowchart in FIG. 1;

FIGS. 7A and 7B are diagrams explaining write pulse waveforms, FIG. 7A showing the write pulse waveforms, observed by the measuring device, corresponding to step S9 of the flowchart in FIG. 1, FIG. 7B showing write pulse waveforms optimized by a conventional method;

FIG. 8 is a block diagram of the structure of an optical disk recording and playback apparatus embodying the write pulse optimizing method according to the embodiment of the present invention; and

FIG. 9 is a diagram explaining write pulses used in a DVD-R as examples of conventional write pulses.

### DESCRIPTION OF THE PREFERRED EMBODIMENTS

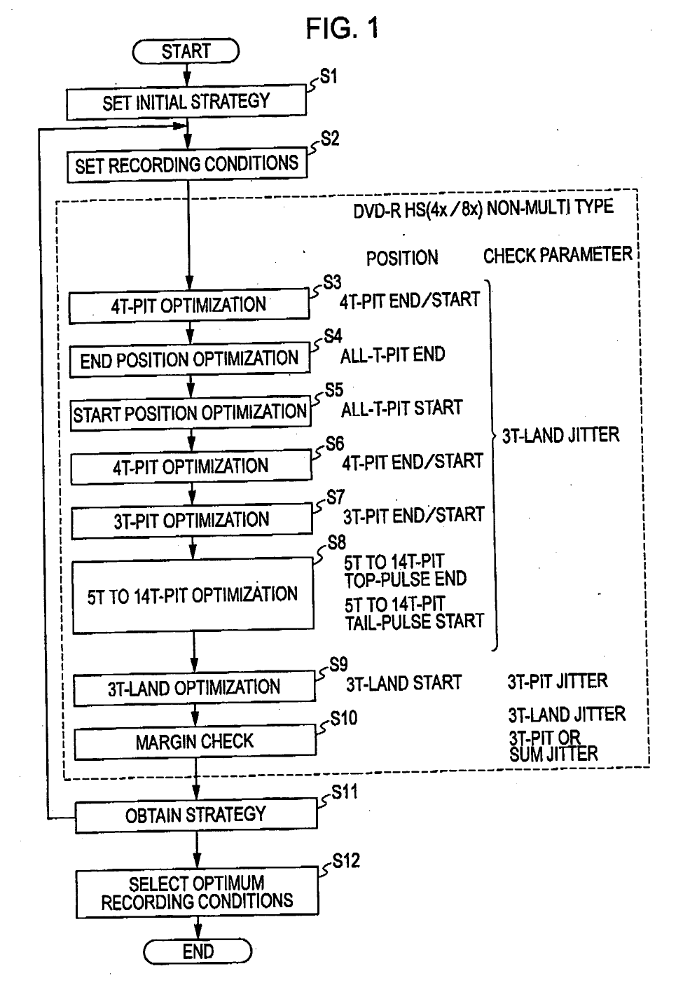

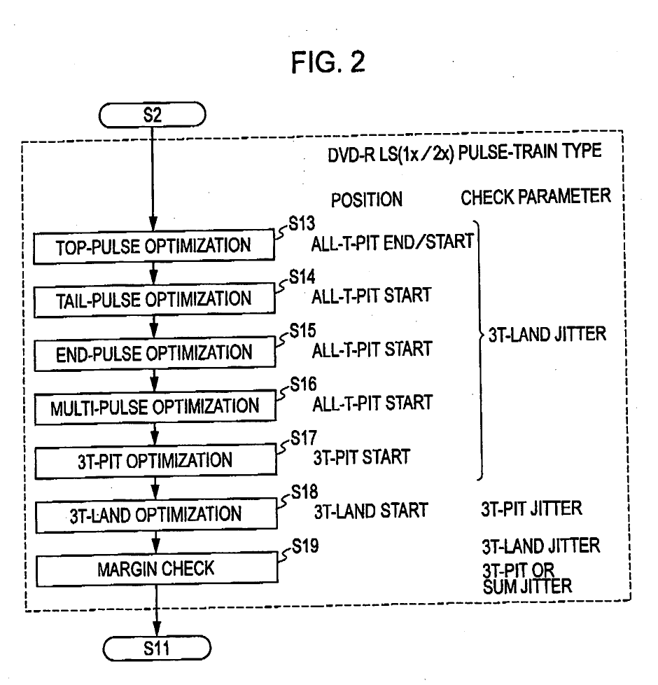

FIGS. 1 and 2 are flowcharts of a process of a write pulse optimizing method according to an embodiment of the present invention.

The present embodiment relates to optimizing write pulses for an optical disk recording apparatus for recording an optical signal to a DVD-R. According to the present embodiment, first, a common write pulse which does not depend on various recording conditions is set. Pulse set positions affecting on recording quality are sequentially determined in accordance with an adjustment sequence, thus obtaining write pulses suitable for an actual operating environment. EFMplus (Eight to Fourteen Modulation Plus) is used as a DVD modulation method. According to EFMplus, 8-bit original data is modulated into 16-bit data.

As mentioned above, DVD-R disks properly use write pulses, which are fundamentally different from each other, corresponding to two modes, i.e., the non-multi type HS (high speed) mode and the pulse-train type LS (low speed) mode. According to the present embodiment, therefore, the write pulse optimization for one mode is slightly different from that for the other mode. An optimization sequence for the non-multi type corresponds to a portion surrounded by a dashed line of FIG. 1. An optimization sequence for the pulse-train type corresponds to a portion surrounded by a dashed line of FIG. 2.

The operation according to the present embodiment will now be described below with reference to FIGS. 1 and 2.

In a write pulse optimizing operation according to the present embodiment, first, a write strategy of a laser drive system using an optical pickup is set to an initial strategy, which is prepared (S1). Recording conditions are set (S2). Then, the operation proceeds to the optimization sequence.

In the non-multi type operation shown in FIG. 1, in a first adjustment block, a write pulse for a 4T-pit length is optimized. In this case, the falling and rising edges (end and start) of a 4T-pit write pulse are set (S3). In the next adjustment block, the falling edge (end) of each of write pulses for all pit lengths (all-T) is set (S4). In the subsequent adjustment block, the rising edge (start) of each of the write pulses for all of the pit lengths (all-T) is set (S5).

In the next adjustment block, the falling and rising edges of the 4T-pit write pulse are again set (S6). In the subsequent adjustment block, the falling and rising edges of a 3T-pit write pulse are set (S7). In the next adjustment block, the falling edge (top end) of a top pulse of each of 5T to 14T-pit write pulses and the rising edge (tail start) of a tail pulse thereof are set (S8).

In the above settings in steps S3 to S8, a jitter measurement value for 3T-land write pulses is used as an evaluation parameter for determination. In the subsequent adjustment block, the rising edge of a 3T-land write pulse is set using a 3T-pit jitter measurement value as an evaluation parameter (S9). In other words, it is optimum to use a 3T-land jitter as an evaluation parameter because the whole recording quality can be provided without being compensated by optical power control. In some cases, a 3T-pit jitter or the sum of the 3T-land and 3T-pit jitters may be used depending on an adjustment position.

After those optimizations, while a 3T-land jitter or another jitter is measured as necessary, optical power margin is checked (S10). A new write strategy is obtained (S11). The process is returned to step S2 as required. Recording conditions such as ambient temperature and the like are changed and the optimization sequence is repeated. Finally, the optimum recording conditions are selected (S12). The process terminates.

On the other hand, in the pulse-train type operation, a write strategy is initially set (S1), recording conditions are set (S2), and after that, the process proceeds to an optimization sequence shown in FIG. 2.

In a first adjustment block, write pulses for all pit lengths (all-T) are optimized, i.e., the rising and falling edges (start and end) of each top pulse are set (313). In the next adjustment block, the rising edge (start) of a tail pulse for each pit length is set (514). In the subsequent adjustment block, the rising edge (start) of an end pulse for each pit length is set (S15). In the next adjustment block, the rising edge (start) of each of multi-pulses of a pulse train for each pit length is set (S16).

In the next adjustment block, the rising edge (start) of a 3T-pit pulse is set (Sl7). In the subsequent adjustment block, the rising edge (start) of a 3T-land pulse is set (S18).

After those optimizations, optical power margin is checked (SI9). The process proceeds to step S11 and subsequent steps. The recording conditions are changed as needed and the optimization sequence is repeated. Finally, the optimum recording conditions are selected (S12). Then, the process terminates.

In the pulse-train type operation, evaluation parameters are fundamentally the same as those of the non-multi type operation.

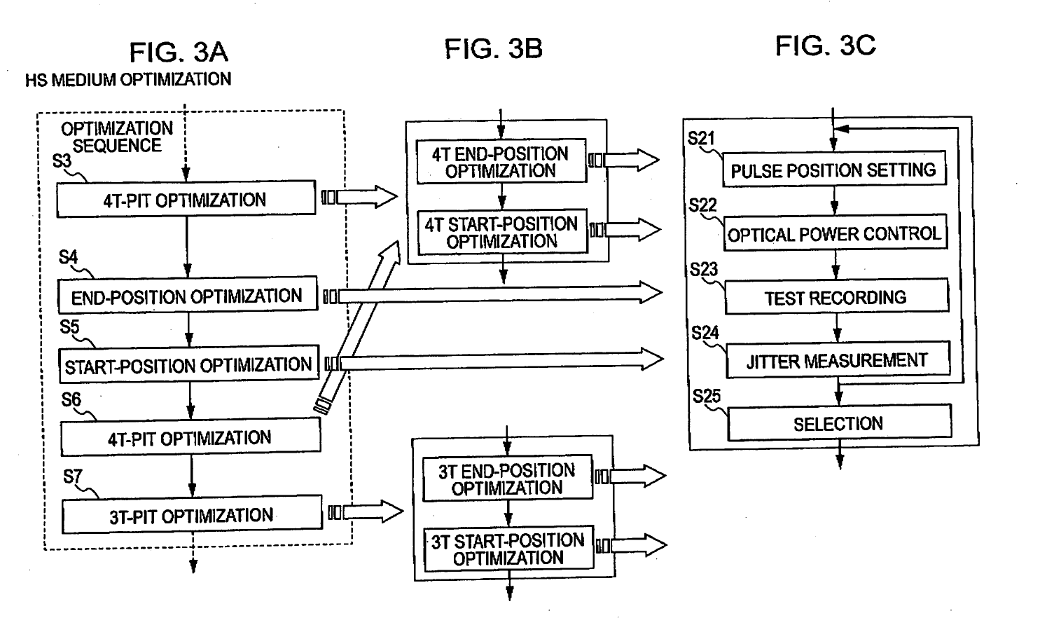

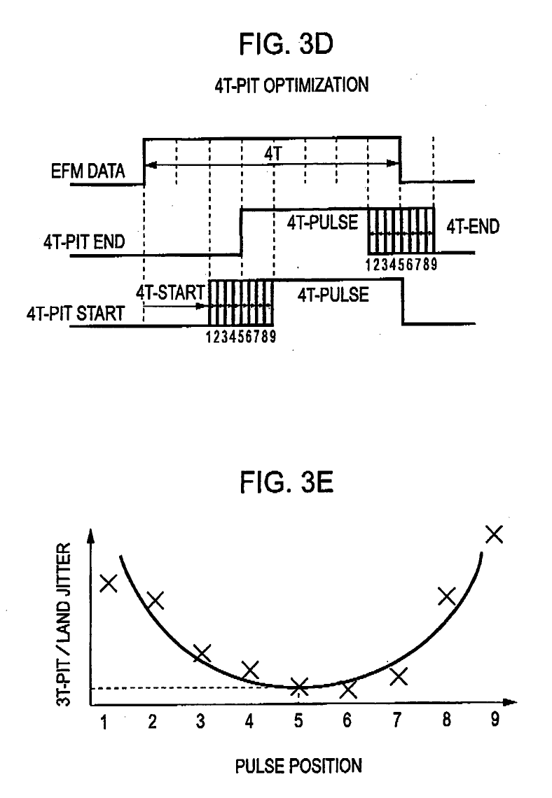

FIGS. 3A to 3D are diagrams explaining specific examples of the optimizations in the respective adjustment blocks.

In each adjustment block, while a pulse set parameter is changed in a predetermined range, the recording conditions are adjusted, a signal is recorded on trial (test recording), and a jitter value obtained by detecting a playback signal is measured. The process including the above steps, i.e., temporary setting of a pulse set parameter, optical power control, test recording, playback, and jitter measurement is repeated. The pulse set parameter for each adjustment block is determined on the basis of results of the measurements.

FIG. 3A shows the adjustment blocks in steps S3 to S7 of the flowchart in FIG. 1. FIG. 3C shows the operation in one adjustment block. Referring to FIG. 3B, steps S3 to S7 in FIG. 3A are classified as shown by arrows. The process in FIG. 3C is performed in each adjustment block.

In other words, in the adjustment block of FIG. 3C, temporary setting (S21) of a pulse set parameter (position), optical power control (S22), test recording (S23), and playback and jitter measurement (S24) are repeated.

A quadratic approximation curve is plotted from the measurement results of jitter values. The pulse set parameter (position) is determined based on the quadratic approximation curve (S25). The process proceeds to the next adjustment block.

FIG. 3D shows the operation of an adjustment block for optimizing a 4T-pit pulse.

As shown in FIG. 3D, while pulse positions as the rising and falling edges of a 4T-pit pulse are being shifted in small pitches, a jitter is repeatedly measured. Results of the measurements are recorded.

FIG. 3E shows the principle of measuring 3T-pit/land jitters to select the optimum pulse position.

As shown in FIG. 3E, a quadratic approximation curve is plotted from the measured jitter values. The optimum pulse position is determined based on the bottom value. In a case shown in FIG. 3E, pulse position 5 corresponds to the bottom. The value is determined as the optimum value. The process proceeds to the next adjustment block. The optimum value of the pulse position is adjusted. The final optimum value is determined in a step-by-step manner.

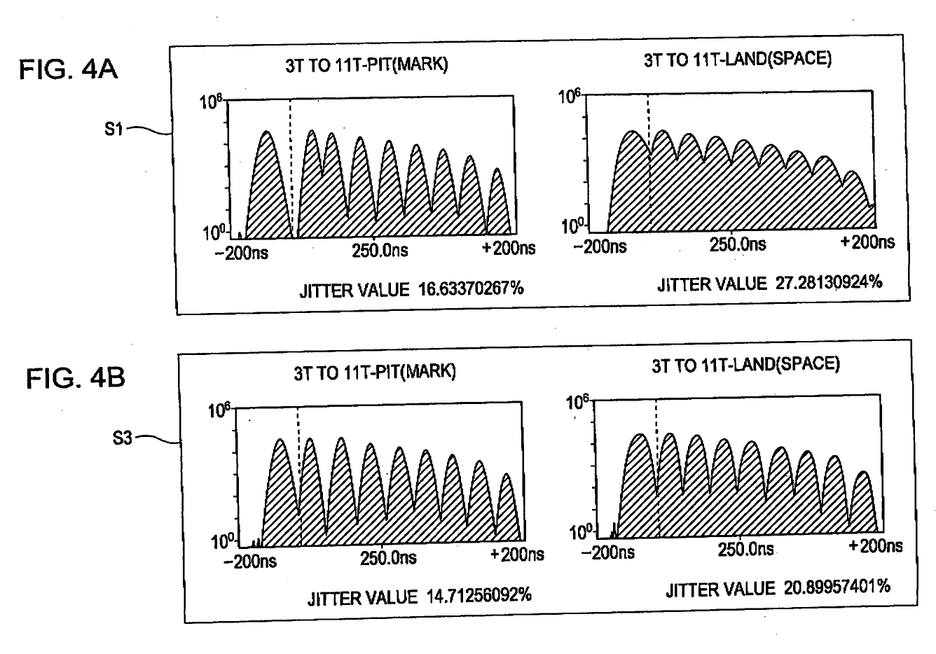

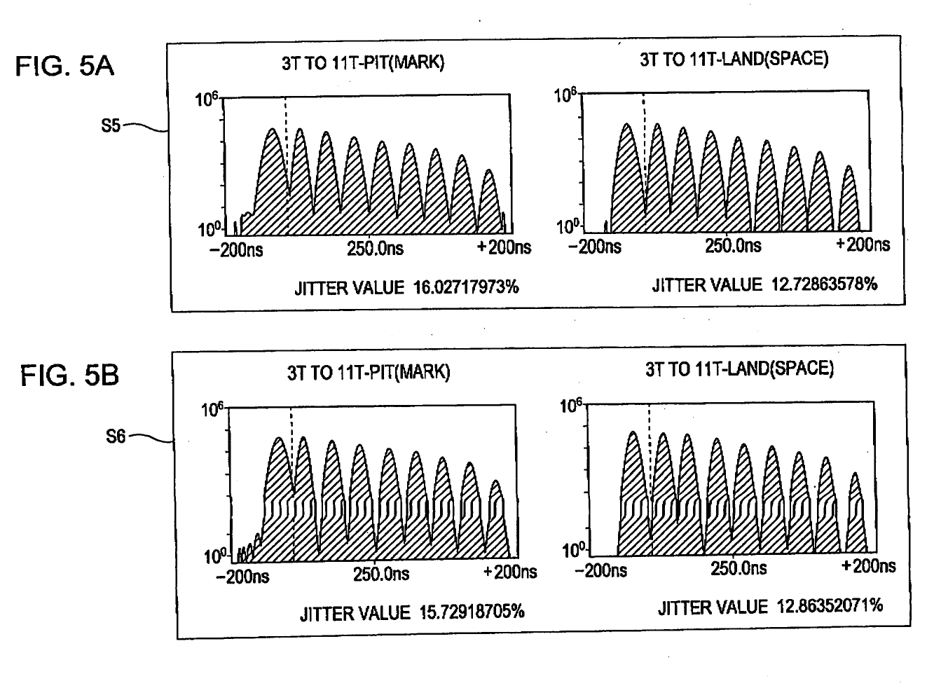

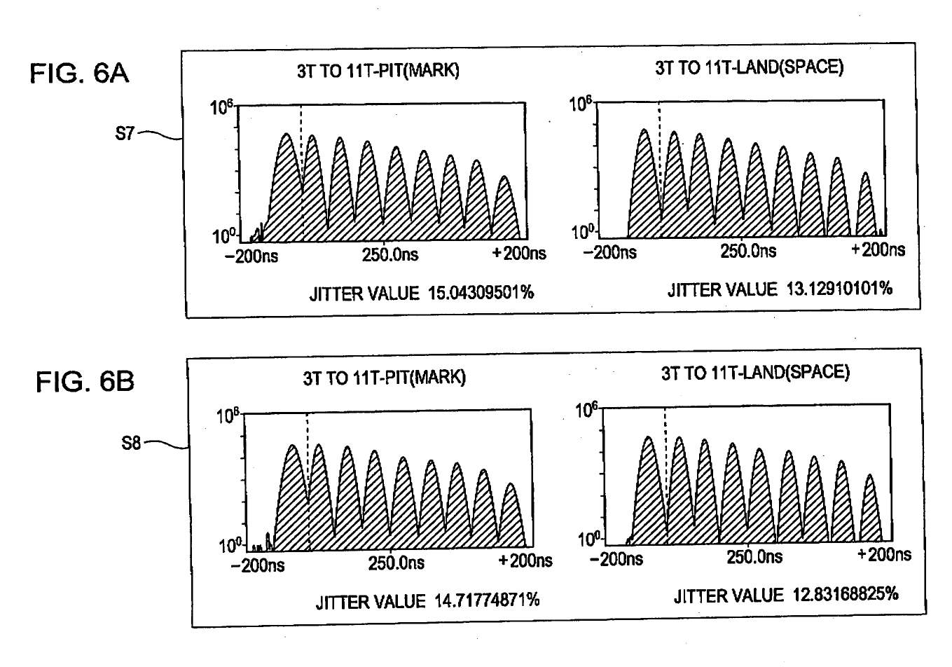

FIGS. 4A to FIG. 7A are diagrams explaining write pulse waveforms observed by a measuring device, the waveforms corresponding to steps S1, S3, and S5 to S9 of the flowchart in FIG. 1.

Referring to FIG. 4A, regarding recording quality by the initial strategy, the duration of each pulse for a 4T pit (mark) is formed long. For land (space), respective periods (T) are not clearly separated from each other. A jitter value is high. Obviously, signal quality is low. However, the recording quality is improved with each adjustment step. At the end of 3T-land optimization, obviously, the optimization is achieved without any problems.

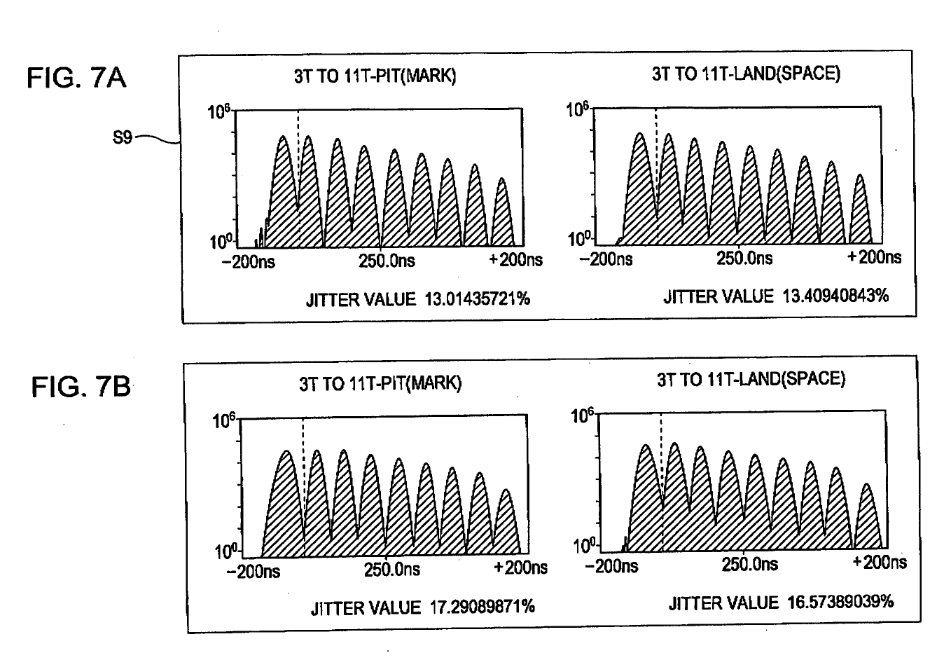

Consequently, it is shown that the recording quality by the write pulse optimization according to the present embodiment bears comparison with that by a write strategy optimized by a conventional method shown in FIG. 7B.

In a case where a jitter is measured on condition that the setting of a measuring device is fixed, if the pulse length for a formed pit and that for a land largely change, an error occurs in a measurement value. Accordingly, normal jitter measurement requires obtaining accurate values including window setting of a measuring device. When an approximation curve is used, like in the present embodiment, a large error does not occur. In other words, the present embodiment has an advantage in that high measurement accuracy is not needed.

As mentioned above, according to the optimization method of the present embodiment, write pulse adjustment is achieved by merely selecting the bottom of the margin curve of jitter measurement values as the optimum setting. Advantageously, therefore, an engineer with no experience can easily perform the optimization.

An optical disk recording and playback apparatus embodying the write pulse optimizing method according to the present embodiment will now be described in brief.

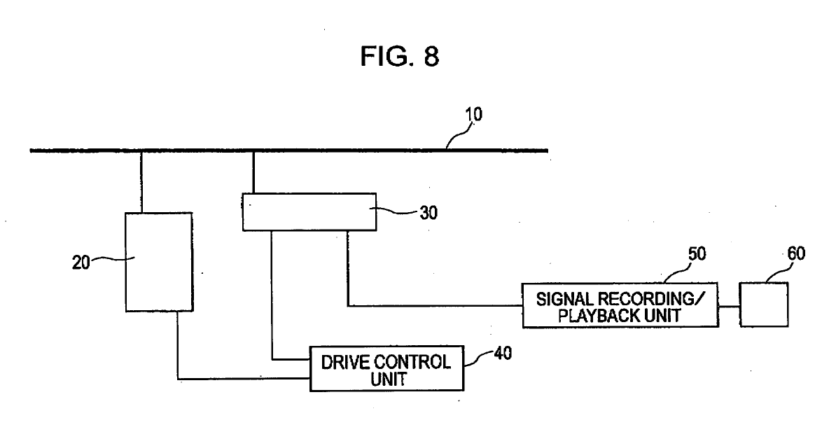

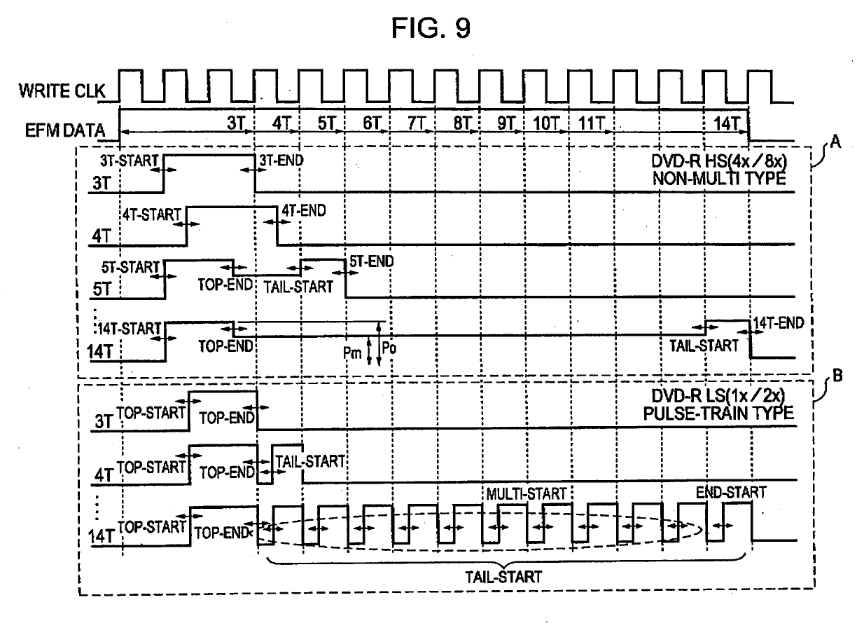

FIG. 8 is a block diagram of the structure of an optical disk recording and playback apparatus used in the present embodiment.

Referring to FIG. 8, the optical disk recording and playback apparatus includes: a disk drive unit 20 for driving an optical disk 10 such as a DVD-R; an optical pickup 30 for scanning a laser beam onto the optical disk 10 to record or play back an information signal; a drive control unit 40 for performing servo control of the disk drive unit 20 or the optical pickup 30; a signal recording/playback unit 50 for processing an information signal recorded or played back through the optical pickup 30; and a data input/output unit 60 for receiving and generating information signals for recording and playback from/to an external device (not shown).

The above mentioned series of write pulse optimization processes is automatically performed by a control circuit or a microcomputer in, e.g., the signal recording/playkback unit 50.

The above embodiment has been explained using a DVD-R as an example of an optical recording medium. The present invention is not limited to this medium. The present invention can also be applied to write pulse optimization in a recordable optical disk drive for a CD recordable (CD-R) or a Blu-ray Disc recordable (BD-R).

Further, erase pulses or write pulses used in overwriting are similarly optimized according to the present invention. Thus, the present invention can also be applied to write pulse optimization in a rewritable optical disk drive for a CD rewritable (CD-RW), a DVD rewritable (DVD-RW), a DVD plus rewritable (DVD+RW), or a BD rewritable .(BD-RE). Further, the same applies to a DVD plus recordable (DVD+R). In addition, the present invention can also be similarly applied to recording methods for various optical disk media which will appear in the future.

1. A write pulse optimizing method for changing a set parameter of a write pulse depending on the length of a pit to be formed in recording write pulses serving as information signals to an optical recording medium to optimize the write pulses, the method comprising the steps of:
a first step of setting a common write pulse which does not depend on individual recording conditions and affects the entire recording operation; and
a second step including a plurality of adjustment blocks for optimizing the set parameter of a write pulse for each pit length depending on the individual recording conditions, wherein
after the common write pulse is set in the first step, the adjustment blocks in the second step are executed in a predetermined order to perform an optimization sequence of step-by-step adjustments of the set parameters of the write pulses.

2. The method according to claim 1, wherein in each of the adjustment blocks, a process of adjusting recording conditions while changing the pulse set parameter in a predetermined range, performing test signal recording, and measuring a jitter value obtained by detecting a playback signal is repeated, and the pulse set parameter for the adjustment block is determined from results of the measurements.

3. The method according to claim 2, wherein in each of the adjustment blocks, a quadratic approximation curve is plotted from the results of the measurements of the jitter values, and the pulse set parameter for the adjustment block is determined based on the quadratic approximation curve.

4. The method according to claim 3, wherein in each of the adjustment blocks, the pulse set parameter for the adjustment block is determined from the bottom value of the quadratic approximation curve plotted from the jitter values.

5. The method according to claim 3, wherein in the test signal recording in each of the adjustment blocks, a process including temporary setting of the pulse set parameter, optical power control, test recording, playback, and jitter measurement is repeated and, after that, the pulse set parameter is determined from a plurality of jitter measurement values.
